(19) United States
(12) Patent Application Publication
(10) Pub. No.: US 2026/0319333 A1
(43) Pub. Date: Oct. 15, 2026

(54) BLADE DRIVE DEVICE

(71) Applicant: ALPS ALPINE CO., LTD., Tokyo (JP)

(72) Inventors: Isamu KIKUCHI, Miyagi (JP); Toshihisa MATSUSHITA, Miyagi (JP)

(21) Appl. No.: 19/687,773

(22) Filed: May 26, 2026

Related U.S. Application Data
(63) Continuation of application No. PCT/JP2024/042000, filed on Nov. 27, 2024.

(30) Foreign Application Priority Data
Dec. 7, 2023 (JP) 2023-207058

(51) Int. Cl. G03B 9/06; G03B 9/22

(52) U.S. Cl. CPC G03B 9/06; G03B 9/22

(57) ABSTRACT

A blade driving device includes: a fixed-side member; a rotation member rotatable relative to the fixed-side member; a plurality of blade members pivotably supported by the fixed-side member and configured to pivot in conjunction with rotation of the rotation member; and a driving mechanism configured to rotate the rotation member. Each blade member pivots in accordance with the rotation of the rotation member, thereby changing a size of an aperture formed by the plurality of blade members. The driving mechanism includes a shape memory alloy wire and a driving body that is swingable. The driving body includes a movable-side wire fixing portion configured to fix one end of the shape memory alloy wire, and an actuator configured to rotate the rotation member. A distance between the actuator and a swing center of the driving body is greater than a distance between the swing center and the movable-side wire fixing portion.

### CROSS-REFERENCE TO RELATED APPLICATIONS

This application is a continuation application of International Application No. PCT/JP2024/042000, filed on Nov. 27, 2024, and designated the U.S., which is based upon and claims priority to Japanese Patent Application No. 2023-207058, filed on Dec. 7, 2023, the entire contents of which are incorporated herein by reference.

### BACKGROUND

### 1. Field of the Invention

The present disclosure relates to a blade driving device.

### 2. Description of the Related Art

A blade driving device configured to rotate a ring member (rotation member) using a shape memory alloy wire to move a plurality of blades, thereby changing the diameter of an aperture of a diaphragm formed by the plurality of blades, is known (see Japanese Patent Application Publication No. 2020-148842). In this device, the shape memory alloy wire includes: an inner circumferential portion and an outer circumferential portion each extending along a circumferential direction of the ring member; and a folded portion connecting the inner circumferential portion and the outer circumferential portion.

### SUMMARY

A blade driving device according to an embodiment of the present disclosure includes: a fixed-side member; a rotation member rotatable relative to the fixed-side member; a plurality of blade members pivotably supported by the fixed-side member and configured to pivot in conjunction with rotation of the rotation member; and a driving mechanism configured to rotate the rotation member. Each of the plurality of blade members pivots in accordance with the rotation of the rotation member, thereby changing a size of an aperture formed by the plurality of blade members. The driving mechanism includes a shape memory alloy wire and a driving body that is swingable. The driving body includes a movable-side wire fixing portion configured to fix one end of the shape memory alloy wire, and an actuator configured to rotate the rotation member. A distance between the actuator and a swing center of the driving body is greater than a distance between the swing center and the movable-side wire fixing portion.

### BRIEF DESCRIPTION OF DRAWINGS

FIG. 1 is a perspective view from above of a blade driving device according to an embodiment of the present disclosure.

FIG. 2 is an exploded perspective view of the blade driving device.

FIG. 3 is a bottom view of a cover member and a blade member.

FIG. 4 is a top view of the blade member and a rotation member.

FIG. 5 is a perspective view from below of the blade driving device.

FIG. 6 is a perspective view from below of the rotation member, a return spring, an intermediate member, a conductive member, and a driving mechanism.

FIG. 7 is a perspective view from above and a perspective view from below of the conductive member and the driving mechanism.

FIG. 8 is a top view and a bottom view of the intermediate member.

FIG. 9 is a bottom view of the blade member, the rotation member, and the driving mechanism.

FIG. 10 is a top view and a bottom view of a return mechanism.

FIG. 11 is a cross-sectional view of a lens body and the blade driving device.

FIG. 12 is a bottom view of the blade driving device according to another embodiment of the present disclosure.

FIG. 13 is a bottom view of the blade driving device according to yet another embodiment of the present disclosure.

### DETAILED DESCRIPTION OF THE DISCLOSURE

In the above-described device, a long shape memory alloy wire having a folded portion is needed to achieve a desired amount of rotation of the ring member.

In view of this, it is desirable to provide a blade driving device configured to rotate a rotation member using a short shape memory alloy wire.

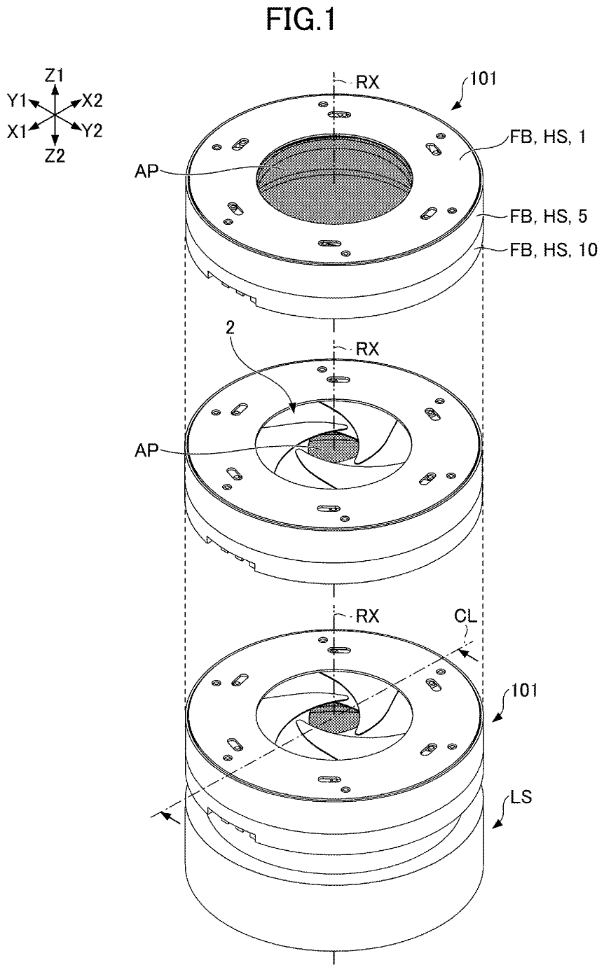

Hereinafter, a blade driving device 101 according to an embodiment of the present disclosure will be described with reference to the drawings. FIG. 1 is a perspective view from above of the blade driving device 101 that functions as a variable diaphragm device. Specifically, the upper portion of FIG. 1 is a perspective view from above of the blade driving device 101 in which an aperture AP of a diaphragm formed by six blade members 2 is in a maximum open state. The center and lower portions of FIG. 1 are perspective views from above of the blade driving device 101 in which the aperture AP of the diaphragm is in a minimum open state. Also, the lower portion of FIG. 1 is a perspective view from above of the blade driving device 101 attached to a lens body LS. Note in FIG. 1 that the aperture AP is provided with a dot pattern for ease of understanding.

In FIG. 1, X1 indicates one direction along an X-axis forming a three-dimensional orthogonal coordinate system, and X2 indicates the other direction along the X-axis. Also, Y1 indicates one direction along a Y-axis forming the three-dimensional orthogonal coordinate system, and Y2 indicates the other direction along the Y-axis. Similarly, Z1 indicates one direction along a Z-axis forming the three-dimensional orthogonal coordinate system, and Z2 indicates the other direction along the Z-axis. In FIG. 1, an X1-side of the blade driving device 101 corresponds to a front side (front surface side) of the blade driving device 101, and an X2-side of the blade driving device 101 corresponds to a rear side (rear surface side) of the blade driving device 101. Also, a Y1-side of the blade driving device 101 corresponds to a left side of the blade driving device 101, and a Y2-side of the blade driving device 101 corresponds to a right side of the blade driving device 101. Also, a Z1-side of the blade driving device 101 corresponds to an upper side (subject side) of the blade driving device 101, and a Z2-side of the blade driving device 101 corresponds to a lower side (imaging element side) of the blade driving device 101. The same applies to the other drawings.

In the illustrated example, the blade driving device 101 is mounted on the upper side (subject side) of the lens body LS, which is a fixed lens, to function as a variable diaphragm device, as illustrated in the lower portion of FIG. 1. Note that the blade driving device 101 may be mounted on the upper side (subject side) of a movable lens moved in an optical axis direction, by an autofocus function, to function as a variable diaphragm device. In this case, the movable lens may be a lens included in a lens driving device having a camera shake correction function of an imaging element shift type. Also, the blade driving device 101 may be moved along with the movable lens. Alternatively, the blade driving device 101 may be mounted inside a lens driving device, including a periscope-type actuator, to function as a variable diaphragm device.

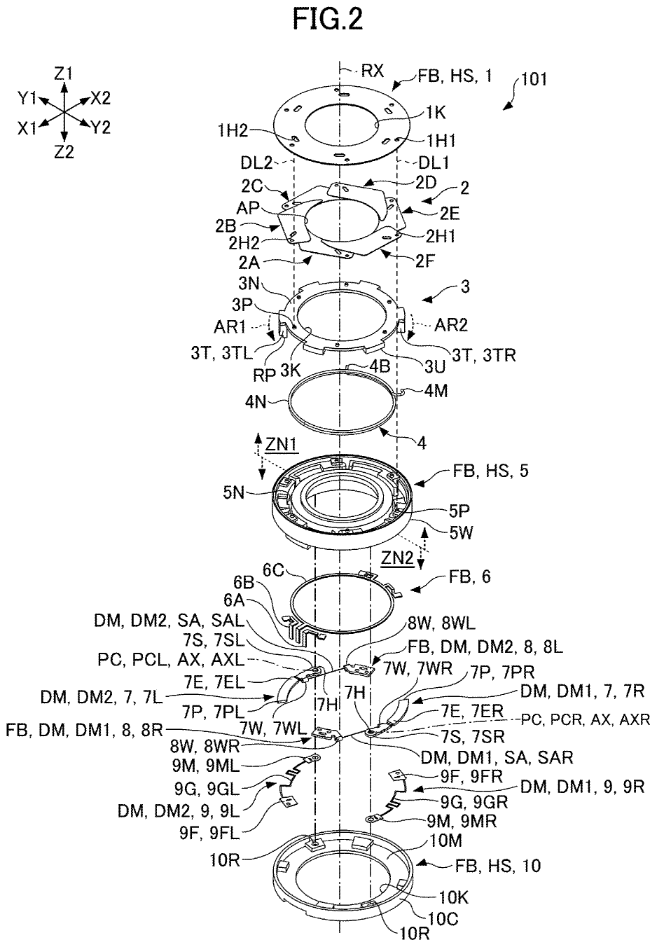

Specifically, as illustrated in FIG. 2, the blade driving device 101 includes a cover member 1, a blade member 2, a rotation member 3, a return spring 4, an intermediate member 5, a conductive member 6, a driving body 7, a fixed-side metal member 8, a flexible metal member 9, a casing member 10, and a shape memory alloy wire SA.

The cover member 1 is a member forming a portion of a housing HS. As illustrated in FIG. 1, the cover member 1 is bonded to the intermediate member 5 by use of an adhesive, welding, or the like, and forms the housing HS along with the intermediate member 5 and the casing member 10. In the illustrated example, the cover member 1 is an annular flat-plate member formed of a synthetic resin, such as polyimide or the like, and includes an opening 1K. The cover member 1 may be formed of a metal.

The blade member 2 is a member forming a diaphragm. In the illustrated example, the blade member 2 is a flat-plate member formed of a synthetic resin, such as polyimide or the like. As illustrated in FIG. 2, the blade member 2 includes a first blade member 2A to a sixth blade member 2F. The first blade member 2A to the sixth blade member 2F have the same shape and the same size. Note that the blade member 2 may be formed of a metal.

The rotation member 3 is a member configured to be rotated by a driving mechanism DM, which is an opening/closing mechanism of the diaphragm. The rotation member 3 is rotatable about a rotation axis RX illustrated in FIG. 1. In the illustrated example, the rotation member 3 is a member formed of a synthetic resin and including an opening 3K, and includes an annular portion 3N. Note that the rotation member 3 may be formed of a metal.

The return spring 4 is a member configured to bias the rotation member 3. In the illustrated example, the return spring 4 is a torsion spring (torsion coil spring). As illustrated in FIG. 2, when the rotation member 3 rotates about the rotation axis RX in a direction indicated by an arrow AR1, the return spring 4 generates a restoring force to rotate the rotation member 3 in a direction indicated by an arrow AR2.

The intermediate member 5 is a member configured to support the driving mechanism DM. In the illustrated example, the intermediate member 5 is a member formed through injection molding of a synthetic resin, and forms the housing HS along with the cover member 1 and the casing member 10.

The driving mechanism DM is a mechanism configured to rotate the rotation member 3 about the rotation axis RX. In the illustrated example, the driving mechanism DM includes the driving body 7, the fixed-side metal member 8, the flexible metal member 9, and the shape memory alloy wire SA. Also, as illustrated in FIG. 2, the driving mechanism DM includes a first driving mechanism DM1 and a second driving mechanism DM2, and is configured to rotate the rotation member 3 in the direction indicated by the arrow AR1 to reduce the aperture AP of the diaphragm.

The shape memory alloy wire SA is an example of a shape memory actuator, and forms the driving mechanism DM. In the illustrated example, the shape memory alloy wire SA includes a right-side wire SAR forming the first driving mechanism DM1, and a left-side wire SAL forming the second driving mechanism DM2. When a current flows through the shape memory alloy wire SA, the temperature increases, and the shape memory alloy wire SA contracts in accordance with the increase in the temperature. The driving mechanism DM can rotate the rotation member 3 by utilizing the contraction of the shape memory alloy wire SA.

The conductive member 6 is a member configured to supply a current to the shape memory alloy wire SA. In the illustrated example, the conductive member 6 is formed of a metal, such as iron or the like. Also, the conductive member 6 is a member partially embedded in the intermediate member 5, and includes a first conductive member 6A to a third conductive member 6C.

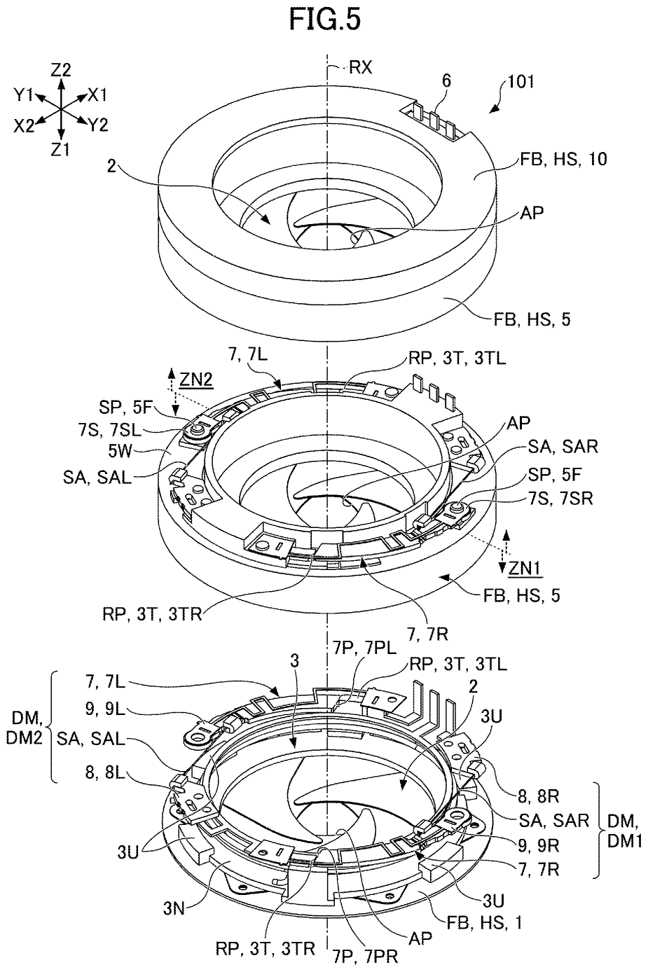

The driving body 7 is a member forming the driving mechanism DM. In the illustrated example, the driving body 7 includes a right driving body 7R forming the first driving mechanism DM1, and a left driving body 7L forming the second driving mechanism DM2. Specifically, the driving body 7 is a cam (a mechanical element configured to change the direction of motion) formed of a metal. The driving body 7 is swingable about a swing axis AX. The driving body 7 includes: a movable-side wire fixing portion 7W, configured to fix one end of the shape memory alloy wire SA; an actuator 7P, configured to transmit a force to the rotation member 3 for rotating the rotation member 3; a supported portion 7S swingably supported by a shaft 5F (see the center view in FIG. 5), serving as a supporting portion SP provided on a fixed-side member FB (intermediate member 5); and an extension 7E located between the actuator 7P and the supported portion 7S. The supported portion 7S includes a through-hole 7H through which the shaft 5F is inserted. More specifically, the right driving body 7R is configured to swing about a right swing axis AXR, and includes a right movable-side wire fixing portion 7WR, a right actuator 7PR, a right supported portion 7SR, and a right extension 7ER. The left driving body 7L is configured to swing about a left swing axis AXL, and includes a left movable-side wire fixing portion 7WL, a left actuator 7PL, a left supported portion 7SL, and a left extension 7EL. Note that the driving body 7 may be partially formed of a metal, and partially formed of a synthetic resin. For example, in the driving body 7, the movable-side wire fixing portion 7W may be formed of a metal, and the actuator 7P may be formed of a synthetic resin.

The fixed-side metal member 8 is a member forming the driving mechanism DM. In the illustrated example, the fixed-side metal member 8 includes a right fixed-side metal member 8R forming the first driving mechanism DM1, and a left fixed-side metal member 8L forming the second driving mechanism DM2.

In the illustrated example, one end of the shape memory alloy wire SA is fixed to the driving body 7, and the other end is fixed to the fixed-side metal member 8, as illustrated in FIG. 2. That is, one end of the right-side wire SAR is fixed to the right driving body 7R, and the other end is fixed to the right fixed-side metal member 8R. Also, one end of the left-side wire SAL is fixed to the left driving body 7L, and the other end is fixed to the left fixed-side metal member 8L. Specifically, the driving body 7 includes the movable-side wire fixing portion 7W to which one end of the shape memory alloy wire SA is fixed. The fixed-side metal member 8 includes the fixed-side wire fixing portion 8W to which the other end of the shape memory alloy wire SA is fixed. More specifically, the right driving body 7R includes the right movable-side wire fixing portion 7WR to which one end of the right-side wire SAR is fixed. The right fixed-side metal member 8R includes a right fixed-side wire fixing portion 8WR to which the other end of the right-side wire SAR is fixed. Also, the left driving body 7L includes the left movable-side wire fixing portion 7WL to which one end of the left-side wire SAL is fixed. The left fixed-side metal member 8L includes a left fixed-side wire fixing portion 8WL to which the other end of the left-side wire SAL is fixed.

Further, in the illustrated example, an intermediate portion between one end of the shape memory alloy wire SA and the other end does not contact any other member, and the intermediate portion is in the form of a straight line during application of a current. However, the intermediate portion may contact other members, and the intermediate portion may be configured not to be in the form of a straight line during application of a current.

In the present embodiment, the fixing, to the driving body 7, of one end of the shape memory alloy wire SA is achieved by bending a portion of the driving body 7, formed by a metal plate, to hold one end of the shape memory alloy wire SA. Therefore, the movable-side wire fixing portion 7W is a holding portion configured to hold one end of the shape memory alloy wire SA. Also, the fixing, to the fixed-side metal member 8, of the other end of the shape memory alloy wire SA is achieved by bending a portion of the fixed-side metal member 8, formed by a metal plate, to hold the other end of the shape memory alloy wire SA. Therefore, the fixed-side wire fixing portion 8W is a holding portion configured to hold the other end of the shape memory alloy wire SA. The fixing of the driving body 7 or the fixed-side metal member 8 to the shape memory alloy wire SA may be achieved by welding or may be reinforced by welding.

The flexible metal member 9 is a member forming the driving mechanism DM, and is formed by, for example, a metal plate, such as a copper alloy or the like. Specifically, the flexible metal member 9 is a member configured to supply a current to the shape memory alloy wire SA, and includes a left flexible metal member 9L and a right flexible metal member 9R. In the illustrated example, the flexible metal member 9 includes: a fixed-side portion 9F fixed to the conductive member 6; a movable-side portion 9M fixed to the driving body 7; and an elastic arm 9G connecting the fixed-side portion 9F and the movable-side portion 9M. Specifically, the left flexible metal member 9L includes a left fixed-side portion 9FL, a left movable-side portion 9ML, and a left elastic arm 9GL, and the right flexible metal member 9R includes a right fixed-side portion 9FR, a right movable-side portion 9MR, and a right elastic arm 9GR.

The casing member 10 is a member forming a portion of the housing HS. As illustrated in FIG. 1, the casing member 10 is bonded to the intermediate member 5 by use of an adhesive, welding, or the like to form the housing HS along with the cover member 1 and the intermediate member 5. In the illustrated example, the casing member 10 is a cylindrical member formed of a synthetic resin, such as an LCP (liquid crystal polymer) or the like, and includes an opening 10K, as illustrated in FIG. 2. Specifically, the casing member 10 includes an annular plate-like portion 10M, and a hollow cylindrical portion 10C extending from an outer edge of the plate-like portion 10M along the rotation axis RX.

As illustrated in FIG. 2, the cover member 1, the blade member 2, the rotation member 3, the return spring 4, and the intermediate member 5 are combined by engaging an engaging portion and an engaged portion provided in each of the members. Specifically, the cover member 1 includes, as the engaged portion, six circular first through-holes 1H1 and six rectangular second through-holes 1H2 having rounded corners. Each of the six blade members 2 includes, as the engaged portion, a circular first through-hole 2H1 and a rectangular second through-hole 2H2 having rounded corners. The rotation member 3 includes, as the engaging portion, six projections 3P projecting upward from the top surface of the annular portion 3N. Also, the intermediate member 5 includes, as the engaging portion, six projections 5P projecting upward from the top surface. Note that the engaging portions (projections) and the engaged portions (through-holes) in the illustrated example may be respectively replaced with the engaged portions (through-holes) and the engaging portions (projections). Also, the through-holes may be cutouts.

More specifically, as indicated by a broken line DL1 in FIG. 2, the six projections 5P of the intermediate member 5 are respectively inserted into the first through-holes 2H1 of the blade member 2 and the first through-holes 1H1 of the cover member 1 such that the six projections 5P are substantially immovable relative to the first through-holes 2H1 within the first through-holes 2H1 and relative to the first through-holes 1H1 within the first through-holes 1H1. Also, as indicated by a broken line DL2 in FIG. 2, the projections 3P of the rotation member 3 are respectively inserted into the second through-holes 2H2 of the blade member 2 and the second through-holes 1H2 of the cover member 1 such that the projections 3P are movable relative to the second through-holes 2H2 within the second through-holes 2H2 and relative to the second through-holes 1H2 within the second through-holes 1H2.

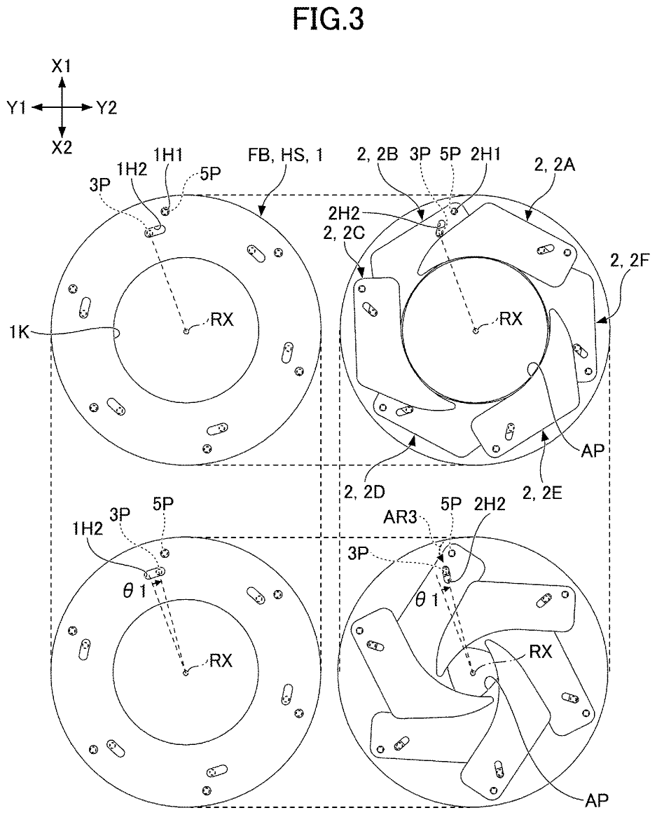

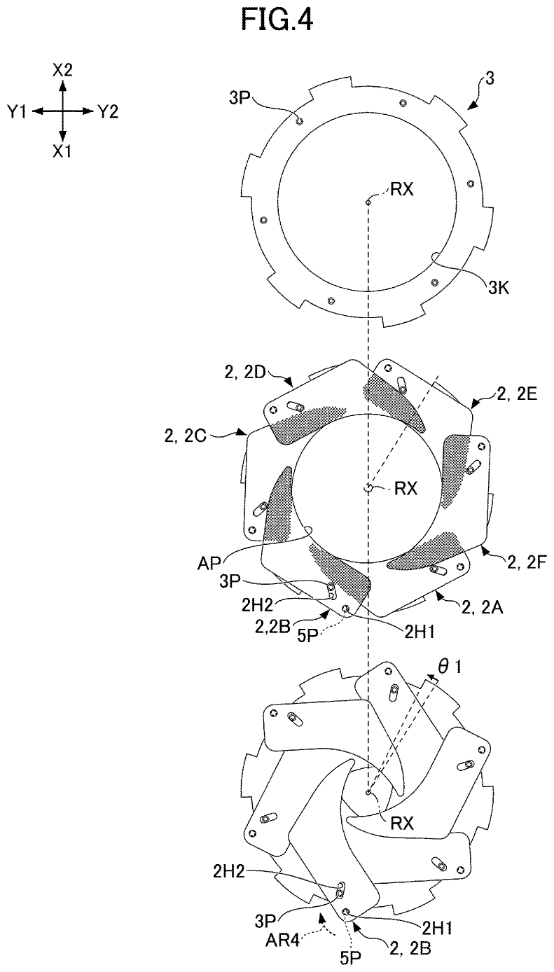

A positional relationship between the cover member 1, the blade member 2, the rotation member 3, and the intermediate member 5 will be described in detail with reference to FIGS. 3 and 4. FIG. 3 is a bottom view of the cover member 1 and the blade member 2. Note in FIG. 3 that, for ease of understanding, the six projections 3P of the rotation member 3 are shown by broken lines, and the six projections 5P of the intermediate member 5 are shown by broken lines. Specifically, the left-upper portion and the left-lower portion of FIG. 3 illustrate a state of the cover member 1 in which the blade member 2 is not attached, and the right-upper view and the right-lower view of FIG. 3 illustrate a state of the cover member 1 in which the blade member 2 is attached. The left-upper portion corresponds to the right-upper portion, and the left-lower portion corresponds to the right-lower portion. Also, the left-upper portion and the right-upper portion illustrate a state in which the aperture AP of the diaphragm is in the maximum open state, and the left-lower portion and the right-lower portion illustrate a state in which the aperture AP of the diaphragm is in the minimum open state. FIG. 4 is a top view of the blade member 2 and the rotation member 3. Specifically, the upper portion of FIG. 4 is a top view of the rotation member 3 to which the blade member 2 is not attached, and the center portion and the lower portion of FIG. 4 are top views of the rotation member 3 to which the blade member 2 is attached. In the center portion and the lower portion of FIG. 4, the six projections 5P of the intermediate member 5 are shown by broken lines for ease of understanding. The upper portion and the center portion of FIG. 4 are views illustrating a state in which the aperture AP of the diaphragm is in the maximum open state, i.e., these correspond to the left-upper portion and the right-upper portion of FIG. 3. The lower portion of FIG. 4 is a view illustrating a state in which the aperture AP of the diaphragm is in the minimum open state, i.e., this corresponds to the left-lower view and the right-lower portion of FIG. 3. Dot-patterned regions in the center portion of FIG. 4 indicate portions where the two blade members 2 next to each other overlap with and contact each other.

More specifically, as illustrated in the right-lower portion of FIG. 3, when the rotation member 3 rotates clockwise, in the bottom portion, with respect to the rotation axis RX by an angle θ 1 from the state illustrated in the right-upper portion of FIG. 3, the projection 3P of the rotation member 3 moves, rightward in the drawing, within the second through-hole 1H2 of the cover member 1 and within the second through-hole 2H2 of the second blade member 2B, and thus the second blade member 2B swings about the corresponding projection 5P in a direction indicated by an arrow AR3.

That is, as illustrated in the lower portion of FIG. 4, when the rotation member 3 rotates counterclockwise, as seen from above, with respect to the rotation axis RX by the angle θ 1 from the state illustrated in the center portion of FIG. 4, the projection 3P of the rotation member 3 moves, leftward in the drawing, within the second through-hole 2H2 of the second blade member 2B, and thus the second blade member 2B swings about the corresponding projection 5P in a direction indicated by an arrow AR4.

The same applies to the first blade member 2A, the third blade member 2C, the fourth blade member 2D, the fifth blade member 2E, and the sixth blade member 2F. As a result, the aperture AP of the diaphragm becomes small until reaching the minimum open state.

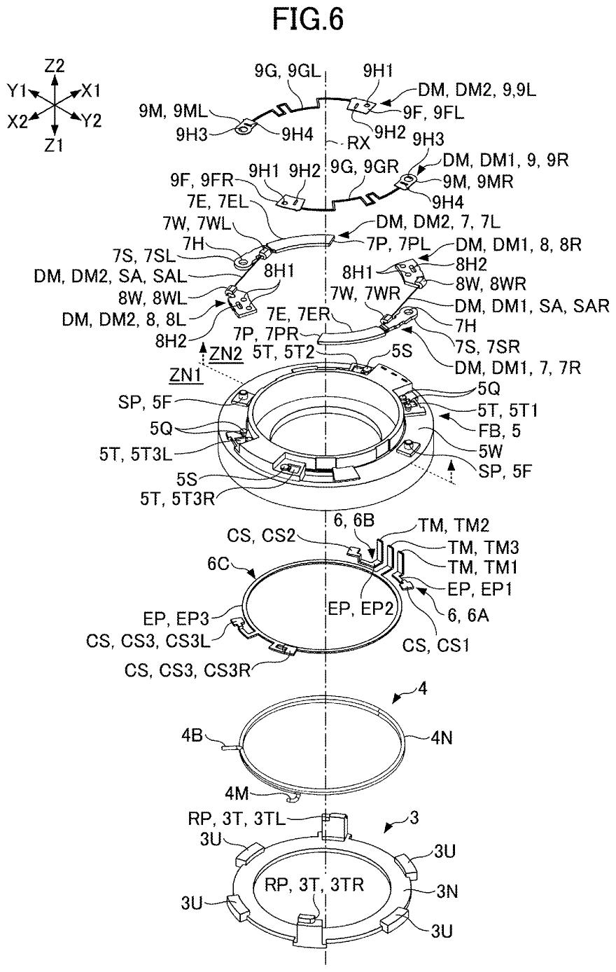

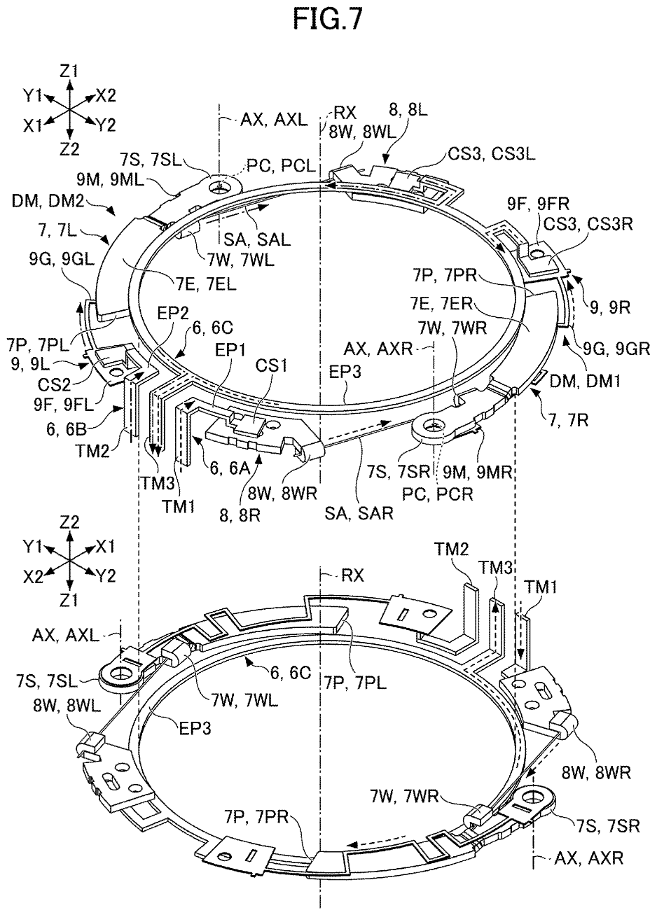

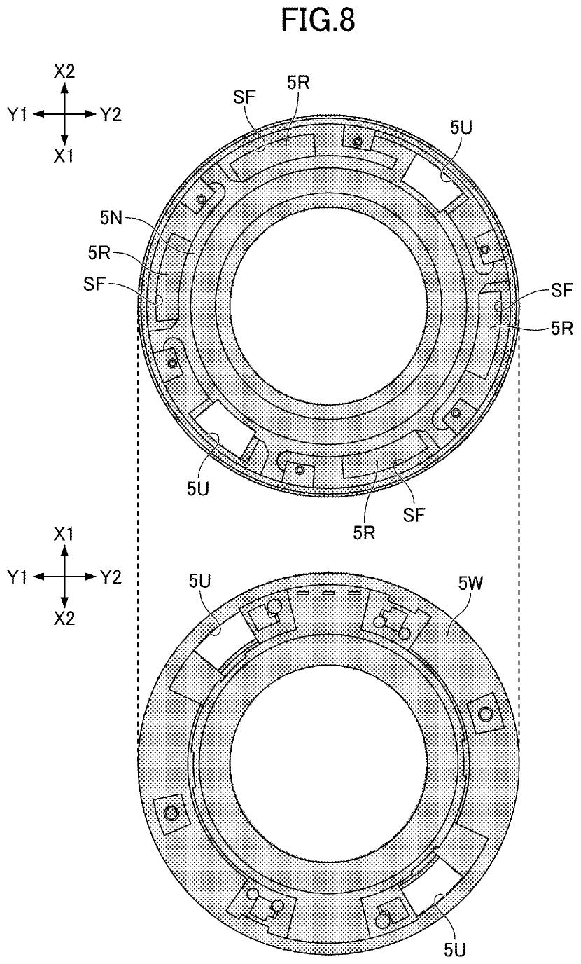

Next, a path of a current flowing through the shape memory alloy wire SA will be described with reference to FIGS. 5 to 8. FIG. 5 is a perspective view from below of the blade driving device 101. Specifically, the upper view of FIG. 5 is a perspective view from below of the blade driving device 101 in which the casing member 10 is attached. The center view of FIG. 5 is a perspective view from below of the blade driving device 101 in which the casing member 10 is removed. The lower view of FIG. 5 is a perspective view from below of the blade driving device 101 in which the intermediate member 5 is further removed. FIG. 6 is a perspective view from below of the rotation member 3, the return spring 4, the intermediate member 5, the conductive member 6, and the driving mechanism DM. FIG. 7 is a view illustrating a positional relationship between the conductive member 6 and the driving mechanism DM in a state in which the conductive member 6 and the driving mechanism DM are combined with each other. Specifically, the upper portion of FIG. 7 is a perspective view from above of the conductive member 6 and the driving mechanism DM, and the lower portion of FIG. 7 is a perspective view from below of the conductive member 6 and the driving mechanism DM. FIG. 8 is a view of the intermediate member 5. Specifically, the upper portion of FIG. 8 is a top view of the intermediate member 5, and the lower portion of FIG. 8 is a bottom view of the intermediate member 5. Note in FIG. 8 that the intermediate member 5 is provided with a dot pattern for ease of understanding.

As illustrated in FIG. 6, the rotation member 3 includes two projections 3T projecting downward from the bottom surface of the annular portion 3N. The two projections 3T form a receiving portion RP configured to receive a force (pressing force) generated by the driving mechanism DM. In the illustrated example, the receiving portion RP is configured to contact the actuator 7P of the driving body 7. However, the receiving portion RP may be configured not to contact the actuator 7P of the driving body 7. In this case, for example, another swingable driving body may be interposed between the receiving portion RP and the actuator 7P of the driving body 7.

As illustrated in FIG. 8, the intermediate member 5 includes an annular wall portion 5W. The wall portion 5W is provided with two through-holes 5U for penetration of the two projections 3T serving as the receiving portions RP.

As illustrated in FIG. 6, the conductive member 6 includes an embedded portion EP embedded in the intermediate member 5, a connecting portion CS exposed to the bottom surface of the intermediate member 5, and a terminal TM provided to project downward from the intermediate member 5. Specifically, the conductive member 6 includes a first conductive member 6A to a third conductive member 6C. The first conductive member 6A includes a first embedded portion EP1, a first connecting portion CS1, and a first terminal TM1. The second conductive member 6B includes a second embedded portion EP2, a second connecting portion CS2, and a second terminal TM2. The third conductive member 6C includes a third embedded portion EP3, a third connecting portion CS3, and a third terminal TM3. The third connecting portion CS3 includes a third left connecting portion CS3L and a third right connecting portion CS3R.

The first connecting portion CS1, the second connecting portion CS2, the third left connecting portion CS3L, and the third right connecting portion CS3R are disposed to be exposed at positions of recesses 5T in the bottom surface of the wall portion 5W of the intermediate member 5. Specifically, the first connecting portion CS1 is disposed to be exposed at the position of a first recess 5T1, the second connecting portion CS2 is disposed to be exposed at the position of a second recess 5T2, the third left connecting portion CS3L is disposed to be exposed at the position of a third left recess 5T3L, and the third right connecting portion CS3R is disposed to be exposed at the position of a third right recess 5T3R.

As illustrated in FIG. 6, the driving body 7 includes: the supported portion 7S swingably connected to the intermediate member 5; the actuator 7P configured to push and move the receiving portion RP provided on the rotation member 3; the movable-side wire fixing portion 7W provided between the supported portion 7S and the actuator 7P; and the extension 7E located between the actuator 7P and the supported portion 7S. Specifically, the left driving body 7L includes the left supported portion 7SL, the left actuator 7PL, the left movable-side wire fixing portion 7WL, and the left extension 7EL. The right driving body 7R includes the right supported portion 7SR, the right actuator 7PR, the right movable-side wire fixing portion 7WR, and the right extension 7ER.

As illustrated in FIG. 6, each of the supported portions 7S is provided with the through-hole 7H for insertion of the cylindrical shaft 5F formed to project downward from the bottom surface of the wall portion 5W of the intermediate member 5. Note that each of the supported portions 7S may be provided with a projection instead of the through-hole 7H. In this case, the wall portion 5W of the intermediate member 5 may be provided with a recess configured to receive this projection. Also, in the illustrated example, the supported portion 7S is supported by the shaft 5F projecting downward from the bottom surface of the wall portion 5W of the intermediate member 5. However, the supported portion 7S may be supported by a projection projecting upward from the top surface of the plate-like portion 10M of the casing member 10.

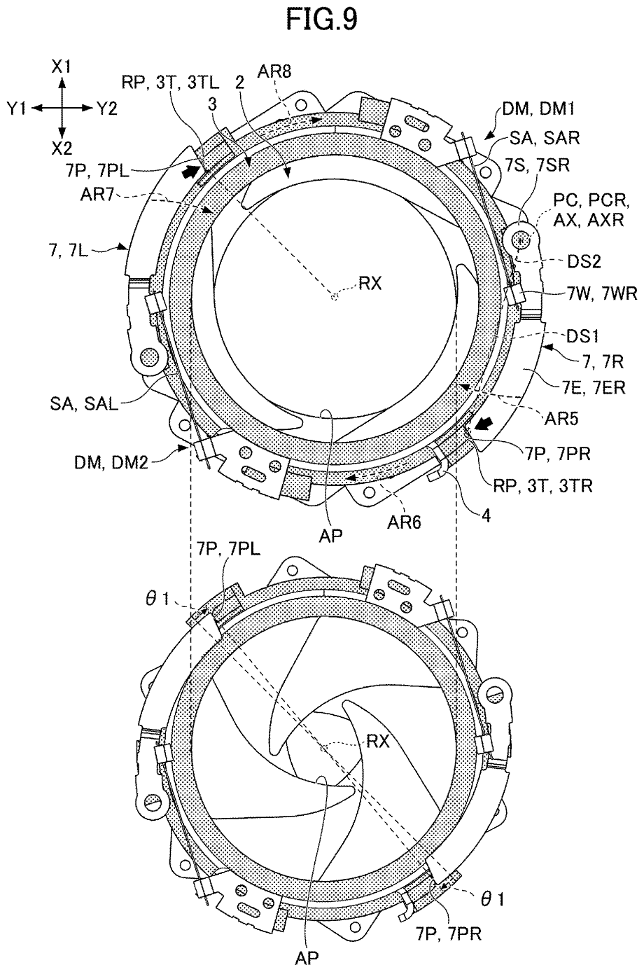

Each of the actuators 7P is disposed to be able to push the projection 3T in a circumferential direction, which is the receiving portion RP in the rotation member 3. Specifically, each of the actuators 7P is a portion extending obliquely along a straight line crossing a circumferential line and a radial line of a circle centered on the rotation axis RX, and is configured to slide in contact with the side surface of the projection 3T. In the illustrated example, each of the actuators 7P is configured to swing about the shaft 5F of the intermediate member 5 and push the projection 3T, serving as the receiving portion RP, by the angle θ 1 in the circumferential direction when a current is supplied to the corresponding shape memory alloy wire SA, as illustrated in FIG. 9.

The fixed-side metal member 8 is a member fixed to the intermediate member 5, and includes the left fixed-side metal member 8L and the right fixed-side metal member 8R. As illustrated in FIG. 6, each of the fixed-side metal members 8 is provided with two first through-holes 8H1 for insertion of two cylindrical projections 5Q formed to project downward from the bottom surface of the wall portion 5W of the intermediate member 5. In the illustrated example, bonding between the intermediate member 5 and each of the fixed-side metal members 8 is achieved by performing hot staking or cold staking on the two projections 5Q inserted into the two first through-holes 8H1. However, bonding between the intermediate member 5 and the fixed-side metal member 8 may be achieved by use of an adhesive.

Also, as illustrated in FIG. 6, each of the fixed-side metal members 8 is provided with a second through-hole 8H2 at the center. The second through-hole 8H2 is used for bonding between the fixed-side metal member 8 and the conductive member 6. In the illustrated example, bonding between the fixed-side metal member 8 and the conductive member 6 is achieved by laser welding. However, bonding between the fixed-side metal member 8 and the conductive member 6 may be achieved by use of solder or a conductive adhesive. In the illustrated example, the right fixed-side metal member 8R is bonded to the first connecting portion CS1 of the first conductive member 6A by laser welding, and the left fixed-side metal member 8L is bonded to the third left connecting portion CS3L of the third conductive member 6C by laser welding.

The flexible metal member 9 is a member fixed to the intermediate member 5, and includes the fixed-side portion 9F, the movable-side portion 9M, and the elastic arm 9G. As illustrated in FIG. 6, each of the fixed-side portions 9F is provided with a first through-hole 9H1 for insertion of a cylindrical projection 5S formed to project downward from the bottom surface of the wall portion 5W of the intermediate member 5. In the illustrated example, bonding between the intermediate member 5 and each of the fixed-side portions 9F is achieved by performing hot staking or cold staking on the projection 5S inserted into the first through-hole 9H1. However, bonding between the intermediate member 5 and the fixed-side portion 9F may be achieved by use of an adhesive.

Also, as illustrated in FIG. 6, each of the fixed-side portions 9F is provided with a second through-hole 9H2. The second through-hole 9H2 is used for bonding between the fixed-side portion 9F and the conductive member 6. In the illustrated example, bonding between the fixed-side portion 9F and the conductive member 6 is achieved by laser welding. However, bonding between the fixed-side portion 9F and the conductive member 6 may be achieved by use of solder or a conductive adhesive. In the illustrated example, the right fixed-side portion 9FR is bonded to the third right connecting portion CS3R of the third conductive member 6C by laser welding, and the left fixed-side portion 9FL is bonded to the second connecting portion CS2 of the second conductive member 6B by laser welding.

Also, as illustrated in FIG. 6, each of the movable-side portions 9M is provided with a third through-hole 9H3 for insertion of the cylindrical shaft 5F formed to project downward from the bottom surface of the wall portion 5W of the intermediate member 5.

Also, as illustrated in FIG. 6, each of the movable-side portions 9M is provided with a fourth through-hole 9H4. The fourth through-hole 9H4 is used for bonding between the movable-side portion 9M and the supported portion 7S of the driving body 7. In the illustrated example, bonding between the movable-side portion 9M and the supported portion 7S is performed by laser welding. However, bonding between the movable-side portion 9M and the supported portion 7S may be achieved by use of solder or a conductive adhesive. In the illustrated example, the right movable-side portion 9MR is bonded to the right supported portion 7SR of the right driving body 7R by laser welding, and the left movable-side portion 9ML is bonded to the left supported portion 7SL of the left driving body 7L by laser welding.

Also, as illustrated in FIG. 2, the plate-like portion 10M of the casing member 10 is provided with a recess 10R that is circular in a top view. The tip of the cylindrical shaft 5F, formed to project downward from the bottom surface of the wall portion 5W of the intermediate member 5, is fitted into the recess 10R.

In the above configuration, when the first terminal TM1 of the first conductive member 6A is connected to a high potential and the third terminal TM3 of the third conductive member 6C is connected to a low potential, a current flows to the third terminal TM3 of the third conductive member 6C through the first conductive member 6A (the first terminal TM1, the first embedded portion EP1, and the first connecting portion CS1), the right fixed-side metal member 8R (the right fixed-side wire fixing portion 8WR), the right-side wire SAR, the right driving body 7R (the right movable-side wire fixing portion 7WR and the right supported portion 7SR), the right flexible metal member 9R (the right movable-side portion 9MR, the right elastic arm 9GR, and the right fixed-side portion 9FR), and the third conductive member 6C (the third right connecting portion CS3R and the third embedded portion EP3), as indicated by a broken-line arrow in the upper portion of FIG. 7.

Also, when the second terminal TM2 of the second conductive member 6B is connected to a high potential and the third terminal TM3 of the third conductive member 6C is connected to a low potential, a current flows to the third terminal TM3 of the third conductive member 6C through the second conductive member 6B (the second terminal TM2, the second embedded portion EP2, and the second connecting portion CS2), the left flexible metal member 9L (the left fixed-side portion 9FL, the left elastic arm 9GL, and the left movable-side portion 9ML), the left driving body 7L (the left supported portion 7SL and the left movable-side wire fixing portion 7WL), the left-side wire SAL, the left fixed-side metal member 8L (the left fixed-side wire fixing portion 8WL), and the third conductive member 6C (the third left connecting portion CS3L and the third embedded portion EP3), as indicated by a one-dot chain line arrow in the upper portion of FIG. 7.

Next, the movement of the driving mechanism DM will be described with reference to FIG. 9. FIG. 9 is a bottom view of the blade member 2, the rotation member 3, the driving mechanism DM, and the return spring 4. Specifically, the upper portion of FIG. 9 is a view in which the aperture AP of the diaphragm is in the maximum open state, and the lower portion of FIG. 9 is a view in which the aperture AP of the diaphragm is in the minimum open state. Note in FIG. 9 that the rotation member 3 is provided with a dot pattern for ease of understanding.

The driving mechanism DM is a mechanism configured to rotate the rotation member 3 about the rotation axis RX, thereby reducing the aperture AP of the diaphragm. The driving mechanism DM includes the driving body 7, the fixed-side metal member 8, the flexible metal member 9, and the shape memory alloy wire SA.

In the illustrated example, the right driving body 7R is configured such that, when no current is supplied to the right-side wire SAR, a distance DS1 between the right actuator 7PR and a right swing center PCR of the right driving body 7R is greater than a distance DS2 between the right movable-side wire fixing portion 7WR and the right swing center PCR of the right driving body 7R, as illustrated in the upper portion of FIG. 9. The same applies to the left driving body 7L.

When the right-side wire SAR is contracted by a current being supplied to the right-side wire SAR forming the first driving mechanism DM1 including the right driving body 7R having such a configuration, the right driving body 7R swings clockwise about the right swing center PCR as seen from below, as indicated by an arrow AR5 in the upper view of FIG. 9. As a result, the right actuator 7PR moves inward (closer to the rotation axis RX) along the circumference of a circle centered on the right swing center PCR. When the right actuator 7PR moves inward, a right projection 3TR (the receiving portion RP) of the rotation member 3 in contact with the right actuator 7PR is pushed by the right actuator 7PR, and the rotation member 3 rotates clockwise as seen from below, as indicated by an arrow AR6 in the upper portion of FIG. 9.

A black block arrow in the upper portion of FIG. 9 indicates that the actuator 7P pushes the projection 3T, which functions as the receiving portion RP.

In other words, when a current is supplied to the right-side wire SAR, as illustrated in the upper portion of FIG. 9, the right actuator 7PR moves inward while pushing the right projection 3TR serving as the receiving portion RP, as indicated by the arrow AR5, thereby moving the right projection 3TR, as indicated by the arrow AR6, to rotate the rotation member 3. Similarly, when a current is supplied to the left-side wire SAL, as illustrated in the upper view of FIG. 9, the left actuator 7PL moves inward while pushing the left projection 3TL serving as the receiving portion RP, as indicated by an arrow AR7, thereby moving the left projection 3TL, as indicated by an arrow AR8, to rotate the rotation member 3. As a result, the blade member 2 swings in accordance with the rotation of the rotation member 3, and thus the aperture AP of the diaphragm is reduced as illustrated in the lower portion of FIG. 9. Note that, when the rotation member 3 rotates, the return spring 4 is compressed to generate a restoring force. Also, when the rotation member 3 rotates by the angle θ 1 as illustrated in the lower portion of FIG. 9, the aperture AP of the diaphragm is in the minimum open state.

Subsequently, when the supply of the current to the shape memory alloy wire SA (the left-side wire SAL and the right-side wire SAR) is stopped, the driving force caused by the contraction of the shape memory alloy wire SA is lost. Therefore, the rotation member 3 is rotated by the return spring 4 counterclockwise as seen from below, and returns to the state illustrated in the upper portion of FIG. 9.

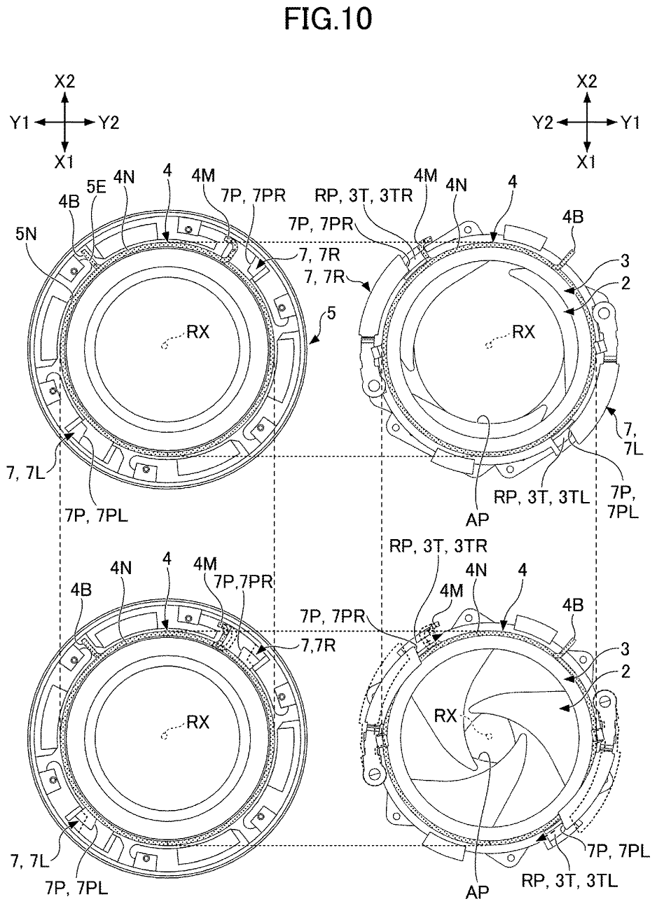

Here, a return mechanism formed by the return spring 4 will be described in detail with reference to FIG. 10. FIG. 10 is a top view and a bottom view of the return mechanism. Specifically, the left-upper portion and the left-lower portion of FIG. 10 are top views of the return spring 4, the intermediate member 5, and the driving body 7, and the right-upper portion and the right-lower portion of FIG. 10 are bottom views of the blade member 2, the rotation member 3, the return spring 4, and the driving body 7. Also, the left-upper portion and the right-upper portion of FIG. 10 are views in which the aperture AP of the diaphragm is in the maximum open state, i.e., when no current is supplied to the shape memory alloy wire SA. The left-lower portion and the right-lower portion of FIG. 10 are views in which the aperture AP of the diaphragm is in the minimum open state, i.e., when a current is supplied to the shape memory alloy wire SA. Note in FIG. 10 that the return spring 4 is provided with a dot pattern for ease of understanding.

The return spring 4 includes: a base end 4B supported by a projecting receiving portion 5E of the intermediate member 5; a movable end 4M configured to be pushed by the projection 3T (the right projection 3TR) of the rotation member 3; and an annular portion 4N housed in an annular recess 5N of the intermediate member 5.

When a current is supplied to the shape memory alloy wire SA, the driving body 7 swings inward as illustrated in the left-lower portion and the right-lower portion of FIG. 10. The actuator 7P of the driving body 7 moves the projection 3T of the rotation member 3, serving as the receiving portion RP, clockwise about the rotation axis RX as seen from below, as illustrated in the right-lower portion of FIG. 10. Since the right projection 3TR of the rotation member 3 rotating clockwise is in contact with the movable end 4M of the return spring 4, the movable end 4M is pushed and moved clockwise. In the left-lower portion and the right-lower portion of FIG. 10, for ease of understanding, the positions of the driving body 7 and the movable end 4M of the return spring 4 when the aperture AP of the diaphragm is in the maximum open state are indicated by a broken line. In the right-lower view of FIG. 10, a moving direction of the projection 3T of the rotation member 3 is indicated by a broken-line arrow.

When the movable end 4M is pushed clockwise, the return spring 4 generates a restoring force to move the projection 3T of the rotation member 3 counterclockwise about the rotation axis RX as seen from below. Therefore, when the supply of the current to the shape memory alloy wire SA is stopped and thus the driving force of the actuator 7P of the driving body 7 to push the projection 3T clockwise is lost, the projection 3T moves counterclockwise and returns to the original position (the position at which the aperture AP of the diaphragm is in the maximum open state).

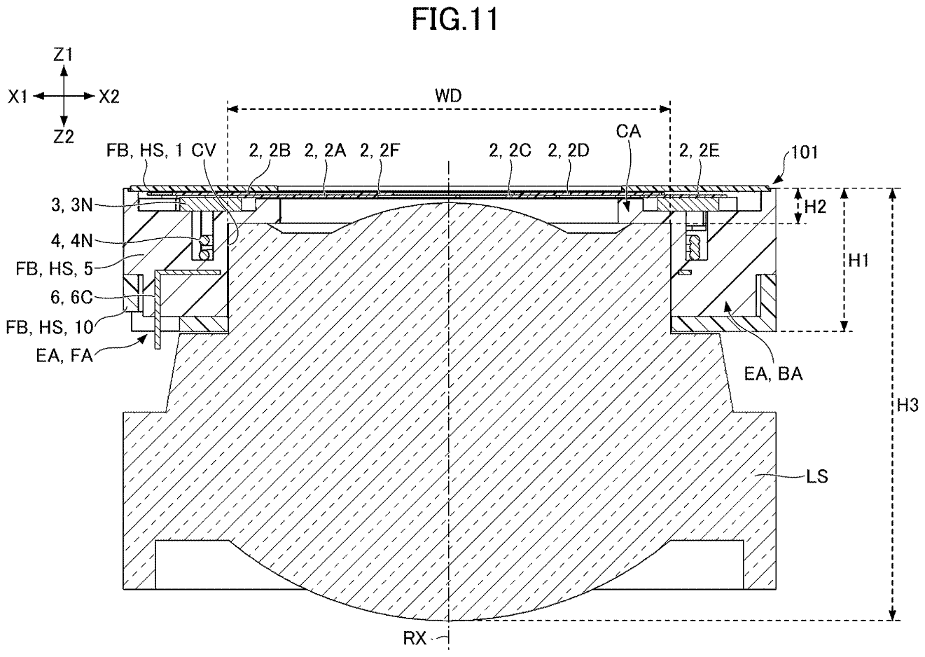

Next, a positional relationship between the lens body LS and the blade driving device 101 will be described with reference to FIG. 11. FIG. 11 is a cross-sectional view of the lens body LS and the blade driving device 101. Specifically, FIG. 11 illustrates a cross section of the lens body LS and the blade driving device 101 in an imaginary plane parallel to an XZ plane including a cutting line CL in the lower portion of FIG. 1.

As illustrated in FIG. 11, the fixed-side member FB including the cover member 1, the intermediate member 5, and the casing member 10 is divided into: two outer portions EA (a front portion FA and a rear portion BA); and an intermediate portion CA. The intermediate portion CA is located between the front portion FA and the rear portion BA. Note in FIG. 11 that, for ease of understanding, a front-to-rear width WD of the intermediate portion CA is indicated by a broken-line double-headed arrow.

As illustrated in FIG. 11, the blade driving device 101 is configured such that a height H1 of the outer portion EA in a direction along the rotation axis RX is greater than a height H2 of the intermediate portion CA. That is, the blade driving device 101 is configured such that the intermediate portion CA forms a recess CV recessed upward in the bottom surface. This relationship similarly applies to a cross section of the lens body LS and the blade driving device 101 in any other imaginary plane including the rotation axis RX.

With this configuration, the blade driving device 101 can receive a portion of the lens body LS in the recess CV. Thus, it is possible to suppress an increase in an overall height H3 of the lens body LS and the blade driving device 101 in the direction along the rotation axis RX.

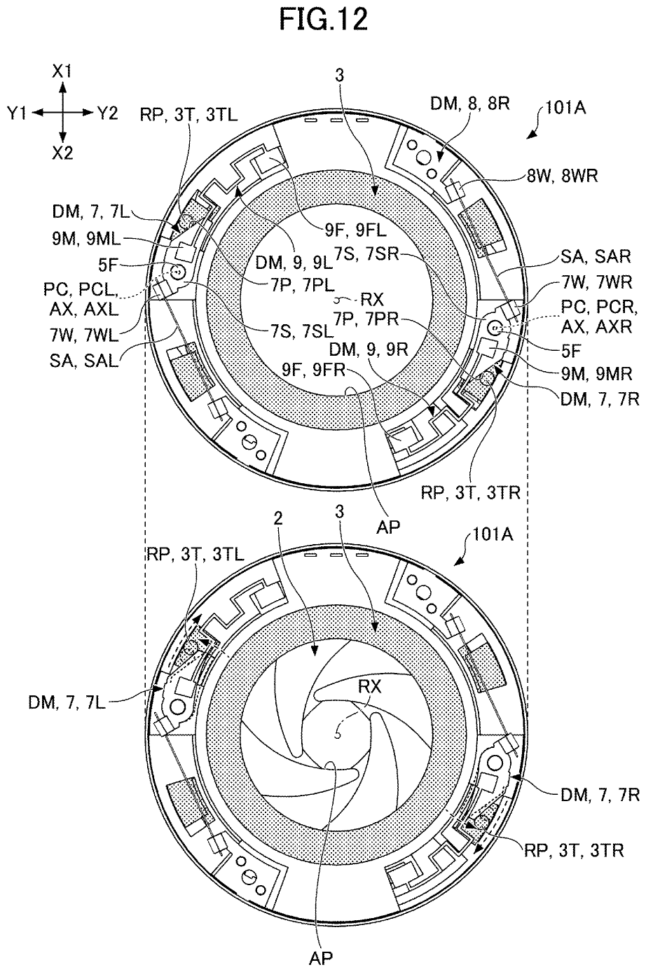

Next, a blade driving device 101A, which is another configuration example of the blade driving device 101, will be described with reference to FIG. 12. FIG. 12 is a bottom view of the blade driving device 101A in which the cover member 1 and the casing member 10 are removed. Specifically, the upper portion of FIG. 12 is a view in which the aperture AP of the diaphragm is in the maximum open state, and the lower portion of FIG. 12 is a view in which the aperture AP of the diaphragm is in the minimum open state. Note in FIG. 12 that the rotation member 3 is provided with a dot pattern for ease of understanding. Also, in the lower portion of FIG. 12, for ease of understanding, the positions of portions of the driving body 7 (the actuator 7P) and the projection 3T of the rotation member 3 when the aperture AP of the diaphragm is in the maximum open state are indicated by a broken line, and the moving direction of the projection 3T and the swinging direction of the driving body 7 are indicated by a broken-line arrow.

The blade driving device 101A is different from the blade driving device 101 in the following manner. Specifically, in the blade driving device 101A, the movable-side wire fixing portion 7W of the driving body 7 is located outside a swing center PC (farther from the rotation axis RX), while in the blade driving device 101 (see FIG. 9), the movable-side wire fixing portion 7W of the driving body 7 is located inside the swing center PC (closer to the rotation axis RX). Therefore, in the blade driving device 101A, when the shape memory alloy wire SA contracts due to a current supplied to the shape memory alloy wire SA, the actuator 7P of the driving body 7 moves outward (farther from the rotation axis RX) along the circumference of a circle centered on the swing center PC. In the blade driving device 101, the actuator 7P of the driving body 7 moves inward (closer to the rotation axis RX) along the circumference of a circle centered on the swing center PC.

The actuator 7P is a portion obliquely extending along a straight line crossing the circumferential line and the radial line of the circle centered on the rotation axis RX, and is configured to slide in contact with the circumferential surface of the cylindrical projection 3T.

Also, in the blade driving device 101A, when viewed from a direction (bottom) along the rotation axis RX of the rotation member 3, a direction (counterclockwise direction) in which the driving body 7 swings about the swing center PC in accordance with the contraction of the shape memory alloy wire SA by application of a current is different from a direction (clockwise direction) in which the rotation member 3 rotates about the rotation axis RX in accordance with the swing of the driving body 7.

In this manner, the driving body 7 may be configured such that the actuator 7P and the movable-side wire fixing portion 7W are positioned on opposite sides with respect to the swing axis AX of the driving body 7.

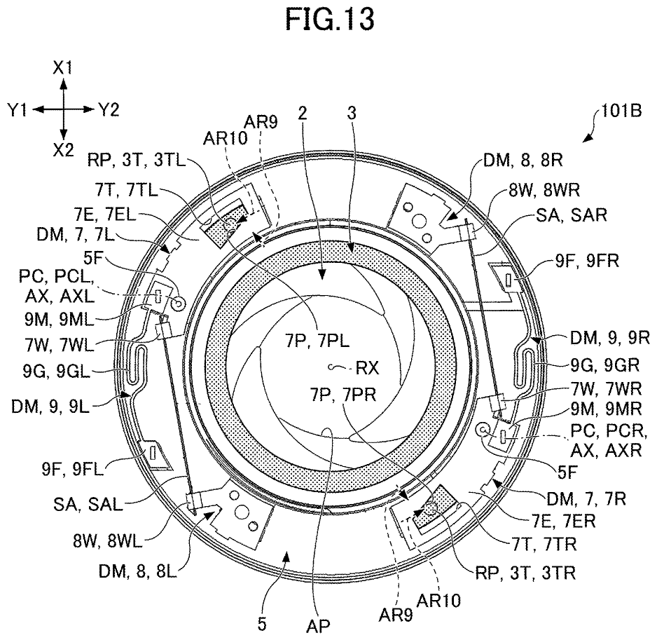

Next, a blade driving device 101B, which is yet another configuration example of the blade driving device 101, will be described with reference to FIG. 13. FIG. 13 is a bottom view of the blade driving device 101B in which the cover member 1 and the casing member 10 are removed. Specifically, FIG. 13 is a view in which the aperture AP of the diaphragm is in an intermediate open state. In the intermediate open state, the size (aperture area or diaphragm diameter) of the aperture AP of the diaphragm is greater than that in the minimum open state and smaller than that in the maximum open state. Note in FIG. 13 that the rotation member 3 is provided with a dot pattern for ease of understanding.

The blade driving device 101B is different from the blade driving device 101A in the following manner. Specifically, in the blade driving device 101B, the actuator 7P of the driving body 7 is formed by the inner edge of a through-hole 7T in the extension 7E of the driving body 7, while in the blade driving device 101A, the actuator 7P of the driving body 7 is formed by the outer edge of the extension 7E. Specifically, the left actuator 7PL of the left driving body 7L is formed by the inner edge of the left through-hole 7TL, and the right actuator 7PR of the right driving body 7R is formed by the inner edge of the right through-hole 7TR.

The actuator 7P is a portion extending obliquely along a straight line crossing the circumferential line and the radial line of the circle centered on the rotation axis RX, and is configured to slide in contact with the circumferential surface of the cylindrical projection 3T.

With this configuration, the actuator 7P of the driving body 7 moves counterclockwise about the swing center PC as seen from below, as indicated by a broken-line arrow AR9. The rotation member 3 rotates counterclockwise about the rotation axis RX as seen from below, as indicated by a broken-line arrow AR10.

In this manner, the actuator 7P may be formed by the inner edge of the through-hole 7T in the extension 7E of the driving body 7.

As described above, the blade driving device 101 according to the embodiment of the present disclosure includes, as illustrated in FIG. 2, the fixed-side member FB, the rotation member 3 rotatable relative to the fixed-side member FB, the plurality of blade members 2 pivotably supported by the fixed-side member FB and configured to pivot in conjunction with the rotation of the rotation member 3, and the driving mechanism DM configured to rotate the rotation member 3. In the blade driving device 101, as illustrated in FIG. 1, each of the plurality of blade members 2 pivots in accordance with the rotation of the rotation member 3, thereby changing the size of the aperture AP formed by the plurality of blade members 2. As illustrated in FIG. 2, the driving mechanism DM includes the shape memory alloy wire SA and the swingable driving body 7. The driving body 7 includes the movable-side wire fixing portion 7W configured to fix one end of the shape memory alloy wire SA, and the actuator 7P configured to rotate the rotation member 3. As illustrated in FIG. 9, the distance DS1 between the actuator 7P and the swing center PC of the driving body 7 is greater than the distance DS2 between the swing center PC and the movable-side wire fixing portion 7W.

This configuration has the effect of being able to reduce the length of the shape memory alloy wire SA. That is, this configuration has the effect of being able to ensure the amount of rotation of the rotation member 3 even if the length of the shape memory alloy wire SA is short.

Also, as illustrated in FIG. 2, the driving body 7 may include the supported portion 7S pivotably supported by the supporting portion SP (the shaft 5F, see the center portion of FIG. 5) provided on the fixed-side member FB (the intermediate member 5). In this case, the swing axis AX of the driving body 7 is desirably configured to be substantially parallel to the rotation axis RX of the rotation member 3.

This configuration has the effect of being able to suppress an increase in the dimension of the blade driving device 101 in the axial direction (Z-axis direction) of the rotation axis RX. This is because the driving body 7 swings along a plane perpendicular to the rotation axis RX. However, in other embodiments, the swing axis AX of the driving body 7 may be configured to cross (not to be parallel to) the rotation axis RX of the rotation member 3.

Also, the blade driving device 101 is desirably configured as illustrated in the upper portion of FIG. 9 such that, when viewed from a direction (bottom) along the rotation axis RX of the rotation member 3, the direction in which the driving body 7 swings in accordance with the contraction of the shape memory alloy wire SA by application of a current (the clockwise direction indicated by the arrow AR5) is the same as the direction in which the rotation member 3 rotates in accordance with the swing of the driving body 7 (the clockwise direction indicated by the arrow AR6).

This configuration has the effect of being able to efficiently rotate the rotation member 3 compared to the configuration illustrated in FIG. 12, in which the swinging direction of the driving body 7 and the rotating direction of the rotation member 3 are opposite. This is because it is possible to reduce a change in the direction of a force transmitted from the driving body 7 to the rotation member 3.

Also, as illustrated in FIG. 7, the driving body 7 may include the extension 7E located between the supported portion 7S and the actuator 7P. In this case, the movable-side wire fixing portion 7W is desirably connected to the extension 7E at a position closer to the swing center PC (the supported portion 7S) of the driving body 7 than to the actuator 7P.

This configuration has the effect of being able to increase the amount of rotation of the rotation member 3 in a simple structure by utilizing the principle of leverage.

The actuator 7P may be provided at a tip end of the extension 7E, as illustrated in FIG. 7, to be able to contact the rotation member 3. In this case, the movable-side wire fixing portion 7W is desirably connected to the extension 7E at a position on the inner circumferential side of the extension 7E. Note that the inner circumferential side means a side closer to the rotation axis RX than is the outer circumferential side.

This configuration has the effect of being able to stably rotate the rotation member 3. This is because the driving body 7, functioning as a cam, directly contacts the rotation member 3 to rotate the rotation member 3. In addition, this configuration has the effect of being able to cause the swinging direction of the driving body 7 and the rotating direction of the rotation member 3 to be the same, thereby efficiently rotating the rotation member 3.

Also, as illustrated in FIG. 2, the fixed-side member FB (the intermediate member 5) may include the wall portion 5W located between a first region ZN1 (upper region) and a second region ZN2 (lower region) in the direction along the rotation axis RX of the rotation member 3. In this case, desirably, the blade member 2 is provided in the first region ZN1, and the shape memory alloy wire SA and the driving body 7 are provided in the second region ZN2.

In other words, the fixed-side member FB (the intermediate member 5) may include the wall portion 5W (partition wall portion) including, in at least a portion, a surface along an imaginary plane (XY plane) perpendicular to the rotation axis RX of the rotation member 3. In the illustrated example, the wall portion 5W includes a bottom surface along the imaginary plane (XY plane) perpendicular to the rotation axis RX of the rotation member 3, as illustrated in the center portion of FIG. 5. In the axial direction (Z-axis direction) of the rotation member 3, the blade member 2 is provided in a region on one side (Z1-side) of the wall portion 5W (the first region ZN1 located on one side (Z1-side) of the wall portion 5W), and the shape memory alloy wire SA and the driving body 7 are provided in a region on the other side (Z2-side) of the wall portion 5W (the second region ZN2 located on the other side (Z2-side) of the wall portion 5W).

In other words, a region where the blade member 2 is provided and a region where the shape memory alloy wire SA and the driving body 7 are provided may be different in the axial direction (Z-axis direction) of the rotation member 3. The fixed-side member FB (the intermediate member 5) may include the wall portion 5W located between the first region ZN1, where the blade member 2 is disposed, and the second region ZN2, where the shape memory alloy wire SA and the driving body 7 are disposed.

This configuration has the effect of being able to prevent the blade member 2 from interfering with the shape memory alloy wire SA and the driving body 7. In addition, this configuration has the effect of being able to reduce the size in the radial direction.

Also, the rotation member 3 may include the annular portion 3N disposed in the first region ZN1, and the projection 3T projecting from the annular portion 3N toward the second region ZN2 (Z2 side, farther away from the blade member 2), as illustrated in FIG. 5. That is, a portion of the projection 3T (the receiving portion RP) may be located in the second region ZN2. In this case, desirably, the wall portion 5W includes the through-hole 5U for insertion of the projection 3T as illustrated in FIG. 8, and the actuator 7P is disposed to be able to contact the receiving portion RP provided in the projection 3T as illustrated in FIG. 5.

This configuration has the effect of being able to reliably transmit the movement of the actuator 7P to the rotation member 3 compared to the configuration in which the actuator 7P and the projection 3T, functioning as the receiving portion RP, are not in direct contact with each other.

Also, as illustrated in FIG. 5, the rotation member 3 may include the annular portion 3N disposed in the first region ZN1, and at least three projections 3U projecting from the annular portion 3N toward the second region ZN2 (Z2 side, farther away from the blade member 2). In the illustrated example, the rotation member 3 includes four projections 3U. In this case, desirably, the wall portion 5W includes a plurality (four) of recesses 5R in which the projections 3U are disposed, as illustrated in the upper view of FIG. 8, and at least a portion of side surfaces SF of the recesses 5R is configured to guide the rotation of the rotation member 3. Note that the recesses 5R may be through-holes.

This configuration has the effect of being able to guide the rotation of the rotation member 3 by the plurality of recesses 5R or through-holes.

Also, as illustrated in FIG. 6, the driving body 7 may be formed of a metal and include a through-hole 7H. In this case, the wall portion 5W desirably includes the shaft 5F (the supporting portion SP) over a surface of the wall portion 5W facing the second region ZN2 (Z2 side), the shaft 5F being configured to pivotably support the driving body 7 and to be inserted into the through-hole 7H. Note that the through-hole 7H may be a through-hole or a cutout.

This configuration has the effect of being able to achieve the driving mechanism DM in a simple structure.

Also, as illustrated in FIG. 6, the fixed-side member FB (the intermediate member 5) may include the conductive member 6 and the fixed-side metal member 8. In this case, desirably, the other end of the shape memory alloy wire SA is fixed to the fixed-side metal member 8, and the driving body 7 is formed of a metal and electrically and mechanically connected to the conductive member 6 via the flexible metal member 9.

This configuration has the effect of readily ensuring a conduction path to the shape memory alloy wire SA. In the illustrated example, the flexible metal member 9 is connected to the outside via the conductive member 6. However, the flexible metal member 9 may be connected to the outside via a flexible printed circuit board. In this case, the flexible printed circuit board may be mounted along the outer circumferential surface of the intermediate member 5, and the conductive member 6 may be omitted.

Also, as illustrated in FIG. 7, the shape memory alloy wire SA and the driving body 7 may be provided as a pair with the rotation axis RX of the rotation member 3 interposed therebetween. In the illustrated example, the first driving mechanism DM1, including the right-side wire SAR and the right driving body 7R, and the second driving mechanism DM2, including the left-side wire SAL and the left driving body 7L, are provided to face each other across the rotation axis RX.

This configuration has the effect of being able to stabilize the rotation of the rotation member 3, and thus stabilize the swing of the blade member 2. Further, this configuration has the effect of being able to increase the driving force caused by the driving mechanism DM.

Also, as illustrated in FIG. 10, the return spring 4 configured to return the rotation member 3 to the initial state may be provided between the fixed-side member FB (the intermediate member 5) and the rotation member 3. In the illustrated example, the initial state means a state in which no current is supplied to the shape memory alloy wire SA, and in the initial state, the aperture AP of the diaphragm is in the maximum open state. The return spring 4 is a torsion spring (torsion coil spring).

This configuration has the effect of being able to suppress undesired swinging of the blade member 2 when not in use (when no current is supplied to the shape memory alloy wire SA).

As illustrated in FIG. 2, the fixed-side member FB may include the housing HS configured to house the rotation member 3 and the driving mechanism DM (the shape memory alloy wire SA and the driving body 7). In this case, in an outer profile of a cross section of the housing HS in an imaginary plane including the rotation axis RX of the rotation member 3 (a second imaginary plane that is perpendicular to a first imaginary plane (XY plane) perpendicular to the rotation axis RX of the rotation member 3, and that includes the rotation axis RX of the rotation member 3), as illustrated in FIG. 11, the two outer portions EA located in a direction (X-axis direction) perpendicular to the axial direction (Z-axis direction) of the rotation axis RX of the rotation member 3 have a dimension (height H1) along the axial direction (Z-axis direction) that is greater than a dimension (height H2) along the axial direction (Z-axis direction) of the intermediate portion CA located between the two outer portions EA. Further, the intermediate portion CA may be the recess CV that is recessed toward a position (Z1 side) at which the blade member 2 is disposed. In other words, the intermediate portion CA may be a lens body-disposed portion that is recessed toward a position (Z1 side) at which the blade member 2 is disposed, and where a portion of the lens body LS can be disposed.

Since a portion of the lens body LS can be disposed in the intermediate portion CA, this configuration has the effect of being able to suppress an increase in the dimension along the axial direction (Z-axis direction) of a camera module including at least the blade driving device 101 and the lens body LS, compared to the configuration in which a portion of the lens body LS cannot be disposed in the intermediate portion CA.

The preferable embodiments of the present invention have been described above in detail. However, the present invention is not limited to the above embodiments. Various modifications, substitutions, and the like are applicable to the above embodiments without departing from the scope of the present invention. The features described with reference to the above embodiments may be appropriately combined as long as there is no technical contradiction.

For example, although, in the above embodiments, the blade member 2 includes six blade members (the first blade member 2A to the sixth blade member 2F) having the same shape and the same size, the blade member 2 may include two to five blade members or seven or more blade members having the same shape and the same size, or may include two or more blade members having different shapes.

In the above blade driving device, the length of the shape memory alloy wire can be reduced.

What is claimed is:

1. A blade driving device, comprising:
a fixed-side member;
a rotation member rotatable relative to the fixed-side member;
a plurality of blade members pivotably supported by the fixed-side member and configured to pivot in conjunction with rotation of the rotation member; and
a driving mechanism configured to rotate the rotation member, wherein
each of the plurality of blade members pivots in accordance with the rotation of the rotation member, thereby changing a size of an aperture formed by the plurality of blade members,
the driving mechanism includes a shape memory alloy wire and a driving body that is swingable,
the driving body includes a movable-side wire fixing portion configured to fix one end of the shape memory alloy wire, and an actuator configured to rotate the rotation member, and
a distance between the actuator and a swing center of the driving body is greater than a distance between the swing center and the movable-side wire fixing portion.

2. The blade driving device according to claim 1, wherein
the driving body includes a supported portion pivotably supported by a supporting portion provided on the fixed-side member, and
a swing axis of the driving body is configured to be substantially parallel to a rotation axis of the rotation member.

3. The blade driving device according to claim 2, wherein
when viewed in a direction along the rotation axis of the rotation member, a direction in which the driving body swings in accordance with contraction of the shape memory alloy wire caused by application of a current is configured to be the same as a direction in which the rotation member rotates in accordance with the swing of the driving body.

4. The blade driving device according to claim 2, wherein
the driving body includes an extension located between the supported portion and the actuator, and
the movable-side wire fixing portion is provided on the extension at a position closer to the swing center of the driving body than to the actuator.

5. The blade driving device according to claim 4, wherein
the actuator is provided at a tip end of the extension to be able to contact the rotation member, and
the movable-side wire fixing portion is connected to the extension at a position on an inner circumferential side of the extension.

6. The blade driving device according to claim 1, wherein
the fixed-side member includes a wall portion located between a first region and a second region along a rotation axis of the rotation member,
the plurality of blade members are provided in the first region, and
the shape memory alloy wire and the driving body are provided in the second region.

7. The blade driving device according to claim 6, wherein
the rotation member includes an annular portion disposed in the first region, and a projection that projects from the annular portion toward the second region,
the wall portion includes a through-hole through which the projection is inserted, and
the actuator is disposed to be able to contact a receiving portion provided in the projection.

8. The blade driving device according to claim 6, wherein
the rotation member includes an annular portion disposed in the first region, and a plurality of projections that project from the annular portion toward the second region,
the wall portion includes a plurality of recesses or through-holes in which the projections are disposed, and
at least a portion of side surfaces of the recesses or the through-holes is configured to guide the rotation of the rotation member.

9. The blade driving device according to claim 6, wherein
the driving body is formed of a metal and includes a through-hole, and
the wall portion includes a shaft over a surface of the wall portion facing the second region, and the shaft is configured to pivotably support the driving body and to be inserted into the through-hole.

10. The blade driving device according to claim 1, wherein
the fixed-side member includes a conductive member and a fixed-side metal member,
another end of the shape memory alloy wire is fixed to the fixed-side metal member, and
the driving body is formed of a metal and is electrically connected to the conductive member via a flexible metal member.

11. The blade driving device according to claim 1, wherein
the shape memory alloy wire and the driving body are provided as a pair with a rotation axis of the rotation member interposed therebetween.

12. The blade driving device according to claim 1, further comprising:
a return spring between the fixed-side member and the rotation member, wherein
the return spring is configured to return the rotation member to an initial state.

13. The blade driving device according to claim 1, wherein
the fixed-side member includes a housing configured to house the rotation member and the driving mechanism,
in a cross-sectional shape of an outer profile of the housing in an imaginary plane including a rotation axis of the rotation member, two outer portions located in a direction perpendicular to an axial direction of the rotation axis of the rotation member have a dimension along the axial direction that is greater than a dimension along the axial direction of an intermediate portion located between the two outer portions, and
the intermediate portion is a recess that is recessed toward positions at which the blade members are disposed.
